(19) United States
(12) Patent Application Publication
(10) Pub. No.: US 2026/0153741 A1
(43) Pub. Date: Jun. 4, 2026

(54) OPTICAL WAVEGUIDE STRUCTURE AND NEAR-EYE DISPLAY DEVICE

(71) Applicants: Interface Advanced Technology (Chengdu) Co., Ltd., Chengdu (CN); Interface Technology (ChengDu) Co., Ltd., Chengdu (CN); INTERFACE OPTOELECTRONICS (SHENZHEN) CO., LTD., Shenzhen (CN); GENERAL INTERFACE SOLUTION LIMITED, Zhunan (TW)

(72) Inventors: YUN-PEI CHEN, Zhunan (TW); Po-Lun Chen, Zhunan (TW); Chia-Chen Kung, Zhunan (TW)

(21) Appl. No.: 19/456,149

(22) Filed: Jan. 22, 2026

Related U.S. Application Data
(63) Continuation-in-part of application No. PCT/CN2025/086149, filed on Mar. 31, 2025.

(51) Int. Cl. G02B 27/01; G02B 27/09; G02B 27/40

(52) U.S. Cl. CPC G02B 27/0172; G02B 27/0955; G02B 27/40; G02B 2027/0178

(57) ABSTRACT

An optical waveguide structure includes: a waveguide used to guide image light and including a first surface and a second surface opposite to the first surface; a coupling-out grating on the first surface and used to couple the image light out of the waveguide; and a first light modulation element on the second surface and on light paths of the image light and ambient light, the first light modulation element including a first light-transmitting surface including a first light modulation region and a second light modulation region connected to the first light modulation region, the first light modulation region being used to adjust a focus of the ambient light, and the second light modulation region being used to adjust a focus of the image light; wherein the first light modulation region and the second light modulation region have different curvatures. A near-eye display device is also provided.

### FIELD

The present disclosure generally relates to near-eye display technology, particularly relates to an optical waveguide structure and near-eye display device.

### BACKGROUND

Near-eye display systems include augmented reality (AR), virtual reality (VR), mixed reality (MR), and extended reality (XR) display systems. The AR display system superimposes and integrates virtual scenes or information with the real environment, creating an interactive presentation where users perceive digital and physical elements coexisting in the same space.

However, for users with refractive errors (such as myopia, hyperopia, and astigmatism), their eyes must constantly refocus to clearly see both virtual content and the real-world surroundings within the same scene. This leads to eye strain and degrades user experience.

### BRIEF DESCRIPTION OF DRAWINGS

FIG. 1 is a schematic diagram of a near-eye device according to an embodiment of the present disclosure.

FIG. 2 is a schematic diagram of an optical system according to an embodiment of the present disclosure.

FIG. 3 is a planar view of an optical waveguide structure shown in FIG. 2.

FIG. 4 is a schematic diagram of sections of a light-modulating element shown in FIG. 2.

FIG. 5 is a schematic diagram of human eye focusing effect after corrected by the optical waveguide structure of the present disclosure.

FIG. 6 is a schematic diagram of an optical system according to another embodiment of the present disclosure.

### DETAILED DESCRIPTION

The technical solutions in the embodiments of the present disclosure will be described clearly and completely below in conjunction with the accompanying drawings. It is apparent that the described embodiments represent only a portion rather than all embodiments of the present disclosure.

It should be noted that when a component is referred to as being “fixed to” or “mounted to” another component, it may be directly attached to said component or intervening components may be present. When a component is considered to be “disposed on” another component, it may be directly placed thereon or intermediate components may coexist.

The term “and/or” as used herein encompasses all possible combinations of one or more related listed items.

The terminology employed in the specification of the present disclosure serves only to describe particular embodiments and is not intended to limit the disclosure.

To further illustrate the technical means employed by the present disclosure to achieve predetermined objectives and the resulting efficacy, the following detailed description will be made with reference to the accompanying drawings and preferred embodiments.

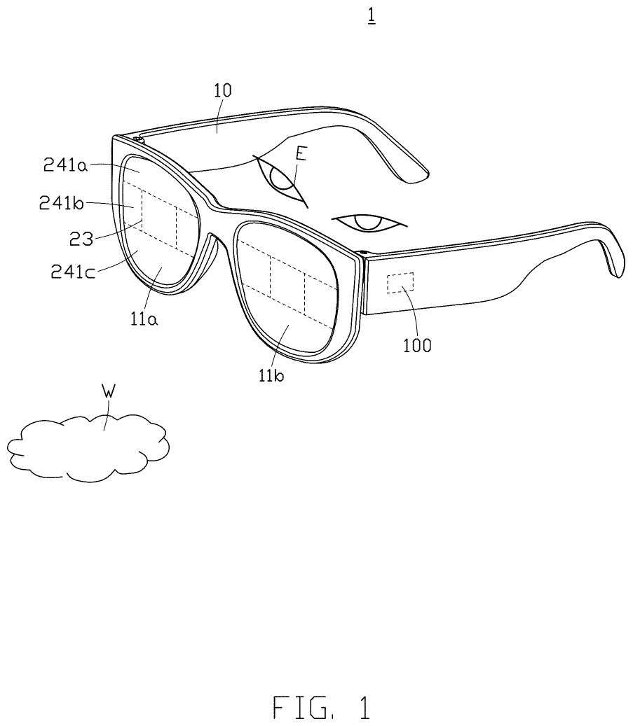

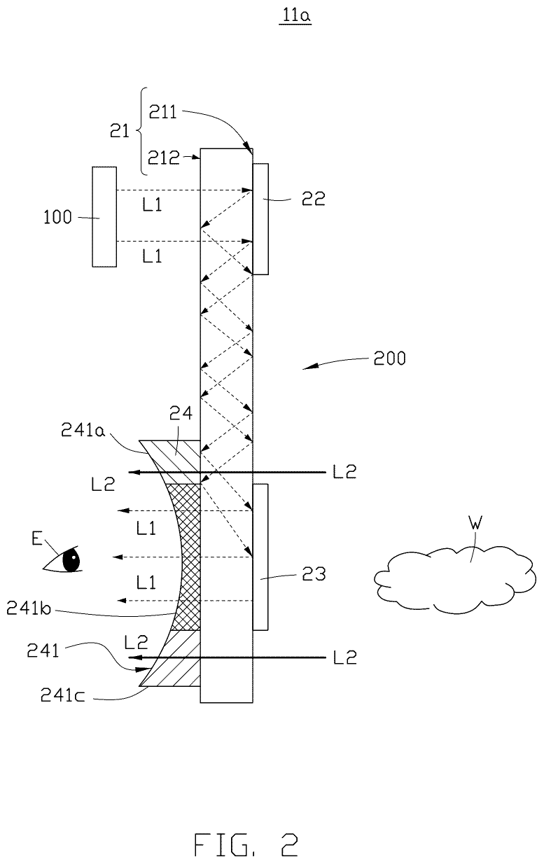

Referring to FIG. 1 and FIG. 2, a near-eye display device 1 in an embodiment of this disclosure includes a frame 10 and two optical systems on the frame 10. The two optical systems are optical system 11a and optical system 11b. The optical system 11a and optical system 11b have basically the same structure and function. The optical system 11a is on a left side of the frame 10 and is used to project images for a user's left eye, and the optical system 11b is on a right side of the frame 10 and is used to project images for the user's right eye.

The near-eye display device 1 in the embodiment of this disclosure is an AR display device. When an user wears the AR display device, the user's eyes can observe the images displayed by the optical system 11a and optical system 11b, and ambient light L2 reflected by objects W in a real world can also enter the user's eyes E through the near-eye display device 1, enabling the user's eyes E to perceive images of the real world, wherein the user's eyes E can observe the projected images superimposed over the real-world image. In other embodiments, the near-eye display device 1 may also be an MR display device or an XR display device, which is not limited.

The following describes the structure and function of the optical system 11a as an example.

Referring to FIG. 1 and FIG. 2, the optical system 11a in the embodiment of this disclosure includes a display assembly 100 and a light waveguide structure 200. The display assembly 100 is embedded in a side of a temple and is used to emit image light L1. The display assembly 100 can be any one of a micro light-emitting diode (Micro LED) display, a mini light-emitting diode (Mini LED) display, or an organic light-emitting diode (OLED) display, which is not limited.

The optical waveguide structure 200 is used to couple the image light L1 to human eye E, and the optical waveguide structure 200 is embedded in the frame 10. In the embodiment of this disclosure, the optical waveguide structure 200 includes a waveguide 21, a coupling-in grating 22, a coupling-out grating 23, and a first light modulation element 24. The waveguide 21 is used to guide the image light L1. The waveguide 21 generally has a rectangular plate-like structure and includes a first surface 211 and a second surface 212 opposite to the first surface 211, with both the first surface 211 and the second surface 212 having a substantially rectangular outline. The material of the waveguide 21 can be formed of transparent glass or plastic, proper plastic includes such as but not limited to polyethylene glycol terephthalate (PET), polycarbonate (PC), or polymeric methyl methacrylate (PMMA).

The coupling-in grating 22 and the coupling-out grating 23 are spaced apart from each other and are positioned on the first surface 211, and the coupling-in grating 22 is used to receive the image light L1 from the display assembly 100 and couple the image light L1 into the waveguide 21. The coupling-out grating 23 is used to couple the image light L1 out of the waveguide 21. The coupling-in grating 22 and the coupling-out grating 23 can be any one of surface relief gratings, volume holographic gratings, and polarization volume holographic gratings, which is not limited.

The first light modulation element 24 is on the second surface 212 and is on light paths of the image light L1 and the ambient light L2, that is, the waveguide 21 is between the coupling-out grating 23 and the first light modulation element 24. When an user wears the near-eye display device 1, a portion of the ambient light L2 reflected by the environmental object W sequentially passes through the waveguide 21 and the first light modulation element 24 before entering an eye box range of the user. Another portion of the ambient light L2 reflected by the environmental object W sequentially passes through the coupling-out grating 23 and the waveguide 21 before entering the first light modulation element 24 and entering the eye box range. The image light L1 emitted by the display assembly 100 sequentially passes through the coupling-in grating 22, the waveguide 21, the coupling-out grating 23, and the first light modulation element 24 before entering the eye box range. The image light L1 and the ambient light L2 entering the eye box range are received by the human eye E together, so that the human eye can observe the AR image.

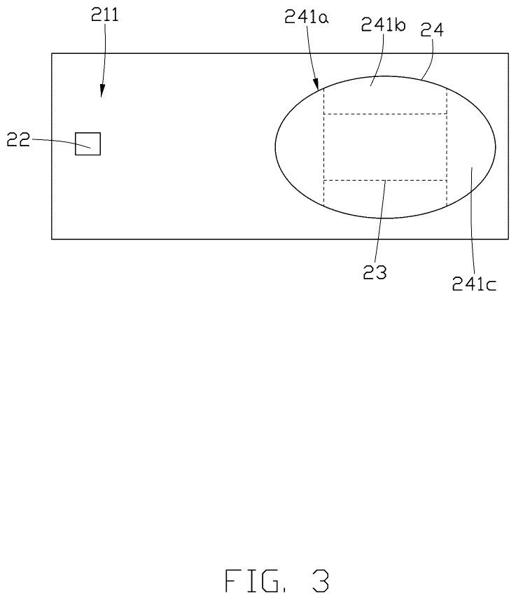

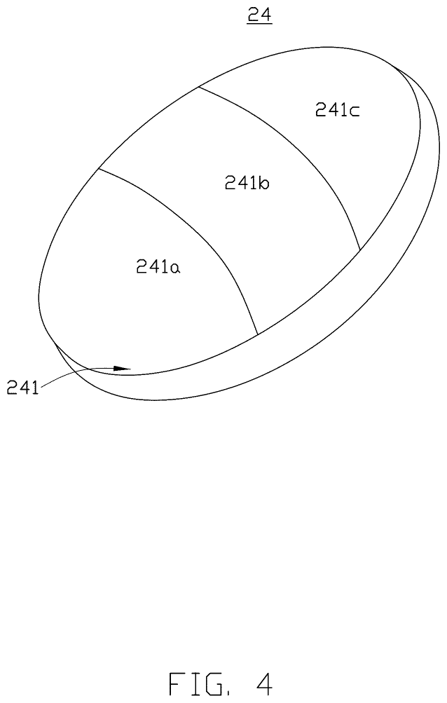

Referring to FIG. 2, FIG. 3, and FIG. 4, material of the first light modulation element 24 can be glass or plastic. The first light modulation element 24 includes a first light modulation surface 241 facing away from the waveguide 21. The first light modulation surface 241 includes a first light modulation region 241a and a second light modulation region 241b connected to the first light modulation region 241a. The first light modulation region 241a and the second light modulation region 241b are spliced together side by side. The first light modulation region 241a is used to adjust a focus of the ambient light L2. An orthographic projection of the second light modulation region 241b on the waveguide 21 completely covers an orthographic projection of the coupling-out grating 23 on the waveguide 21, so that the image light L1 from the coupling-out grating 23 can be fully received by the second light modulation region 241b, which is used to adjust a focus of the image light L1. The first light modulation element 24 can adjust the focuses of the image light L1 and the ambient light L2 so that the focuses both fall on the user's retina.

The first light modulation region 241a and the second light modulation region 241b have different curvatures, that is, the first light modulation region 241a and the second light modulation region 241b of the first light modulation element 24 have different focal lengths, that is, the first light modulation region 241a and the second light modulation region 241b of the first light modulation element 24 have different refractive powers. For example, the refractive power of the first light modulation region 241a is 0 D, and the refractive power of the second light modulation region 241b is 1 D.

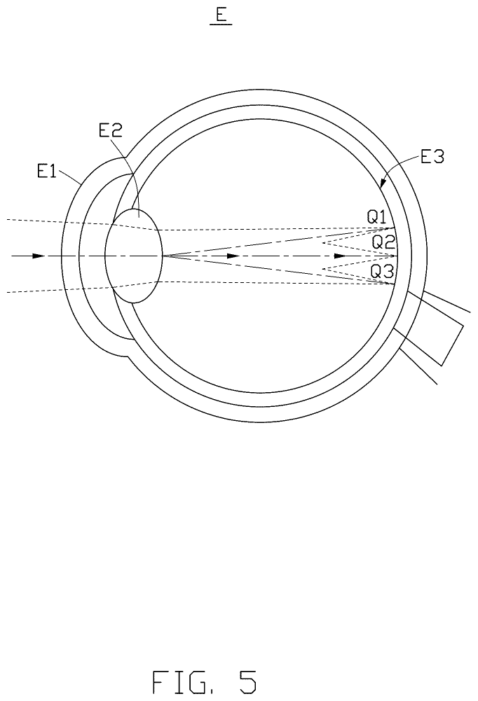

Referring to FIG. 2 and FIG. 5, in some embodiments, the first light modulation element 24 is a negative lens, and the first light-transmitting surface 241 is a concave surface, which can have a diverging effect on light. For myopic users, light will be focused in front of a retina E3 after passing through a cornea E1 and a crystalline lens E2, and cannot be precisely focused on the retina E3, resulting in the human eye E only being able to see nearby objects and unable to see distant objects. In this embodiment, the first light modulation region 241a and the second light modulation region 241b are spliced together, and the first light modulation region 241a and the second light modulation region 241b have different curvatures and refractive powers (for example, the refractive power of the first modulation region 241a is 0 D and the refractive power of the second light modulation region 241b is set to 1 D), this allows the ambient light L2 incident from a distance onto the first modulation region 241a to be focused onto a focal point Q1 of the retina E3 after passing through the cornea E1 and the crystalline lens E2. Meanwhile, the image light L1 emitted from the coupling-out grating 23 enters the second light modulation region 241b, which exerts a diverging effect on the image light L1. This shifts a virtual image point formed by the image light L1 from optical infinity toward a position closer to the eye E, thereby enabling the image light L1 to converge onto a retinal focal point Q2 after refraction by the cornea E1 and the crystalline lens E2.

In some embodiments, the first light modulation element 24 further includes a third light modulation region 241c connected to the second light modulation region 241b and is also used to adjust the focus of the ambient light L2. The second light modulation region 241b is between the first light modulation region 241a and the third light modulation region 241c. The curvatures of the first light modulation region 241a, the second light modulation region 241b, and the third light modulation region 241c are different, that is, the focal lengths of the first light modulation region 241a, the second light modulation region 241b, and the third light modulation region 241c of the first light modulation element 24 are different, that is, the refractive powers of the first light modulation region 241a, the second light modulation region 241b, and the third light modulation region 241c of the first light modulation element 24 are different. For example, the refractive power of the first light modulation region 241a is 0 D, the refractive power of the second light modulation region 241b is 1 D, and the refractive power of the third dimming zone 241c is 2 D.

The first light modulation region 241a, the second light modulation region 241b, and the third light modulation region 241c of the first light modulation element 24 have different refractive powers, this allows the ambient light L2 incident from a distance onto the first modulation region 241a to be focused onto the focal point Q1 of the retina E3 after passing through the cornea E1 and the crystalline lens E2. Meanwhile, the image light L1 emitted from the coupling-out grating 23 enters the second light modulation region 241b, which exerts a diverging effect on the image light L1. This shifts a virtual image point formed by the image light L1 from optical infinity toward a position closer to the eye E, thereby enabling the image light L1 to converge onto a retinal focal point Q2 after refraction by the cornea E1 and the crystalline lens E2. The ambient light L2 incident from a near-field distance onto the third modulation region 241c is focused onto a focal point Q3 of the retina E3 after passing through the cornea E1 and the crystalline lens E2. Thus, when users with refractive errors (e.g., myopia) wear the aforementioned near-eye display device 1, they can clearly view nearby scenery through the first light modulation region 241a, clearly perceive displayed images through the second light modulation region 241b, and maintain clear near-field vision through the third light modulation region 241c. This enables users with refractive errors to simultaneously observe both the real environment and virtual scenes formed by image light L1, helping reduce visual fatigue and thereby improving user experience.

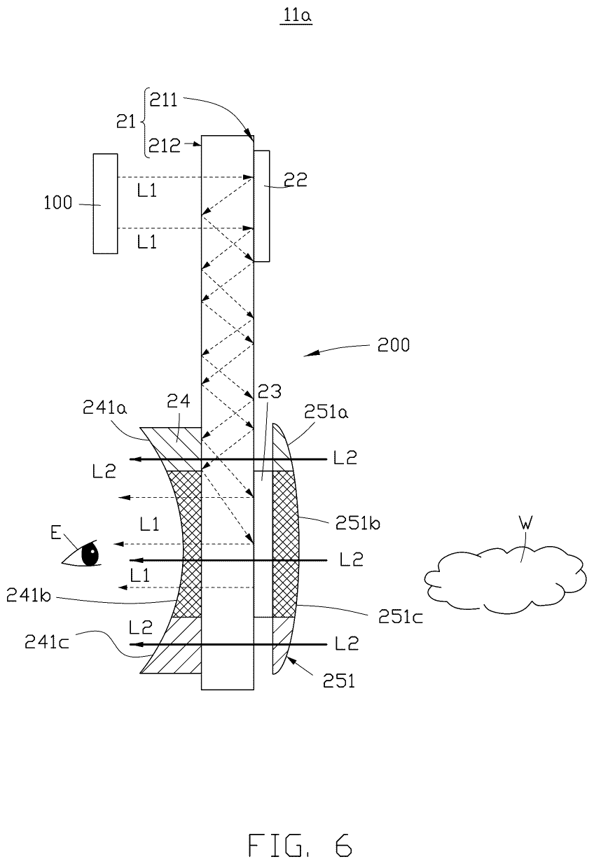

Referring to FIG. 5 and FIG. 6, in some embodiments, the optical waveguide structure 200 further includes a second light modulation element 25. The material of the second light modulation element 25 can be glass or plastic. The second light modulation element 25 is on a side of the coupling-out grating 23 away from the waveguide 21 and is on the light path of the ambient light L2. The second light modulation element 25 is used to receive the ambient light L2 and adjust the focus of the ambient light L2. An orthographic projection of the second light modulation element 25 on the waveguide 21 completely covers the coupling out grating 23. The second light modulation element 25 is a positive lens, which includes a second light-transmitting surface 251 facing away from the waveguide 21. The second light-transmitting surface 251 is a convex surface for converging light.

The second light-transmitting surface 251 includes a fourth light modulation region 251a, a fifth light modulation region 251b, and a sixth light modulation region 251c sequentially connected. The fourth light modulation region 251a, the fifth light modulation region 251b, and the sixth light modulation region 251c are spliced side by side. The fifth light modulation region 251b is between the fourth light modulation region 251a and the sixth light modulation region 251c, and an optical axis of the second light modulation element 25 intersects with the fifth light modulation region 251b. The fourth light modulation region 251a, the fifth light modulation region 251b, and the sixth light modulation region 251c are used to adjust the focus of the ambient light L2, respectively.

An orthographic projection of the fifth light modulation region 251b on the waveguide 21 covers the orthographic projection of the coupling-out grating 23 on the waveguide 21. The orthographic projection of the fifth light modulation region 251b on the waveguide 21 and the orthographic projection of the coupling-out grating 23 on the waveguide 21 have approximately the same area. Thus, the ambient light L2 passing through the fifth light modulation region 251b, the coupling-out grating 23, the waveguide 21, and the first light modulation element 24 and the image light L1 emitted from the coupling-out grating 23 are incident on the eye box range. The image light L1 and the ambient light L2 are received by the human eye E together, so that the human eye can observe the AR image.

In some embodiments, the fourth light modulation region 251a, the fifth light modulation region 251b, and the sixth light modulation region 251c have different curvatures, focal lengths, and refractive powers. For example, the refractive power of the fourth dimming zone 251a is 0 D, the refractive power of the fifth dimming zone 251b is 1 D, and the refractive power of the sixth dimming zone 251c is 2 D. The refractive power of the fourth dimming zone 251a is the same as that of the first light modulation region 241a, the refractive power of the fifth light modulation region 251b is the same as that of the second light modulation region 241b, and the refractive power of the sixth light modulation region 251c is the same as that of the third light modulation region 241c.

Since the fourth light modulation region 251a, the fifth light modulation region 251b, and the sixth light modulation region 251c of the second light modulation element 25 have different refractive powers, when users with refractive errors (such as hyperopia) wear the above-mentioned near-eye display device 1, if the first light modulation region 241a and the fourth light modulation region 251a are in an upper part (i.e., the upper viewing area observed by human eye E) of the lens, the second light modulation region 241b and the fifth modulation region 251b are in a middle part(i.e., the upper-middle viewing area observed by human eye E) of the lens, and the third light modulation region 241c and the sixth light modulation region 251c are in a lower part(i.e., the lower viewing area observed by human eye E) of the lens, the ambient light L2 incident from far distances passing through the fourth light modulation region 251a can sequentially pass through the fourth light modulation region 251a, the waveguide 21, the first light modulation region 241a, the cornea E1, and the crystalline lens E2 to focus on the retina E3, allowing the users to clearly see distant scenery through the first light modulation region 241a and fourth light modulation region 251a, that is, the human eye E can see distant objects clearly through the upper part of the lens. The ambient light L2 incident from nearby distances passing through the sixth light modulation region 251c can sequentially pass through the sixth light modulation region 251c, the waveguide 21, the third light modulation region 241c, the cornea E1, and the crystalline lens E2 to focus on the retina E3, allowing the users to clearly see nearby scenery through the third light modulation region 241c and the sixth light modulation region 251c, that is, the human eye E can see nearby objects clearly through the lower part of the lens. The users can observe displayed images clearly through the second light modulation region 241b. Since the fifth light modulation region 251b is used to adjust the focus position of the ambient light L2, the users can observe mid-distance scenery clearly through the fifth light modulation region 251b, which enables the users to simultaneously see both the real environment and virtual scenery formed by image light L1, effectively reducing eyeglass fatigue for users with refractive errors and thereby improving the user experience.

The near-eye display device 1 provided in the embodiments of the present disclosure can adjust the focus of the ambient light L2 and the image light L1 by the first light modulation 24 of the optical waveguide structure 200 in any of the above embodiments, which makes the image light L1 and the ambient light L2 focusing on the retina E3 after passing through the first light modulation element 24 and the human eye lens E2, so that users with refractive errors can see both the real environment and the virtual scenery formed by the image light L1 at the same time, which is conducive to reducing the fatigue of glasses for users with refractive errors and improving their user experience.

The embodiments shown and described above are only examples. Many details are often found in the art such as the other features of a light-emitting assembly and a display device. Therefore, many such details are neither shown nor described. Even though numerous characteristics and advantages of the present technology have been set forth in the foregoing description, together with details of the structure and function of the present disclosure, the disclosure is illustrative only, and changes may be made in the detail, especially in matters of shape, size, and arrangement of the parts within the principles of the present disclosure, up to and including the full extent established by the broad general meaning of the terms used in the claims. It will therefore be appreciated that the embodiments described above may be modified within the scope of the claims.

What is claimed is:

1. An optical waveguide structure comprising:
a waveguide configured to guide image light and comprising a first surface and a second surface opposite to the first surface;
a coupling-out grating on the first surface and configured to couple the image light out of the waveguide; and
a first light modulation element on the second surface and on light paths of the image light and ambient light, the first light modulation element comprising a first light-transmitting surface facing away from the waveguide and comprising a first light modulation region and a second light modulation region connected to the first light modulation region, wherein the first light modulation region is configured to adjust a focus of the ambient light, and the second light modulation region is configured to adjust a focus of the image light; and
a curvature of the first light modulation region is different form a curvature of the second light modulation region.

2. The optical waveguide structure according to claim 1, wherein the first light modulation element is a negative lens, and the first light-transmitting surface is a concave surface.

3. The optical waveguide structure according to claim 1, wherein an orthographic projection of the second light modulation region on the waveguide covers an entirety of an orthographic projection of the coupling-out grating on the waveguide.

4. The optical waveguide structure according to claim 1, wherein the first light modulation element further comprises a third light modulation region connected to the second light modulating region and is configured to adjust the focus of the ambient light; and
the second light modulation region is between the first modulation region and the third modulation region, and the curvature of the first modulation region, the curvature of the second modulation region, and a curvature of the third modulation region are different from each other.

5. The optical waveguide structure according to claim 1, further comprising a second light modulation element on a side of the coupling-out grating away from the waveguide and on the optical path of the ambient light, wherein the second light modulation element is configured to receive the ambient light and adjust the focus of the ambient light.

6. The optical waveguide structure according to claim 5, wherein the second light modulation element comprises a second light-transmitting surface facing away from the waveguide, and the second light-transmitting surface is convex.

7. The optical waveguide structure according to claim 6, wherein the second light-transmitting surface comprises a fourth light modulation region and a fifth light modulation region connected to the fourth light modulation region, the fourth light modulation region and the fifth light modulation region are configured to respectively adjust the focus of the ambient light, and a curvature of the fourth light modulation region is different from a curvature of the fifth light modulation region.

8. The optical waveguide structure according to claim 7, wherein a refractive power of the fourth light modulation region is same as a refractive power of the first light modulation region, and a refractive power of the fifth modulation region is same as a refractive power of the second modulation region.

9. The optical waveguide structure according to claim 7, wherein an orthographic projection of the fifth light modulation region on the waveguide covers an entirety of an orthographic projection of the coupling-out grating on the waveguide.

10. The optical waveguide structure according to claim 1, further comprising a coupling-in grating on the first surface and spaced apart from the coupling-out grating, wherein the coupling-in grating is configured to couple the image light into the waveguide.

11. A near-eye display device comprising:
a display assembly configured to emit image light; and
an optical waveguide structure comprising:
a waveguide configured to guide image light and comprising a first surface and a second surface opposite to the first surface;
a coupling-out grating on the first surface and configured to couple the image light out of the waveguide; and
a first light modulation element on the second surface and on light paths of the image light and ambient light, the first light modulation element comprising a first light-transmitting surface facing away from the waveguide and comprising a first light modulation region and a second light modulation region connected to the first light modulation region, wherein the first light modulation region is configured to adjust a focus of the ambient light, and the second light modulation region is configured to adjust a focus of the image light; and
a curvature of the first light modulation region is different form a curvature of the second light modulation region, and the first light modulation element is configured to transmit the image light and the ambient light into human eye.

12. The near-eye display device according to claim 11, wherein the first light modulation element is a negative lens, and the first light-transmitting surface is a concave surface.

13. The near-eye display device according to claim 11, wherein an orthographic projection of the second light modulation region on the waveguide covers an entirety of an orthographic projection of the coupling-out grating on the waveguide.

14. The near-eye display device according to claim 11, wherein the first light modulation element further comprises a third light modulation region connected to the second light modulating region and is configured to adjust the focus of the ambient light; and
the second light modulation region is between the first modulation region and the third modulation region, and the curvature of the first modulation region, the curvature of the second modulation region, and a curvature of the third modulation region are different from each other.

15. The near-eye display device according to claim 11, wherein the optical waveguide structure further comprises a second light modulation element on a side of the coupling-out grating away from the waveguide and on the optical path of the ambient light, and the second light modulation element is configured to receive the ambient light and adjust the focus of the ambient light.

16. The near-eye display device according to claim 15, wherein the second light modulation element comprises a second light-transmitting surface facing away from the waveguide, and the second light-transmitting surface is convex.

17. The near-eye display device according to claim 16, wherein the second light-transmitting surface comprises a fourth light modulation region and a fifth light modulation region connected to the fourth light modulation region, the fourth light modulation region and the fifth light modulation region are configured to respectively adjust the focus of the ambient light, and a curvature of the fourth light modulation region is different from a curvature of the fifth light modulation region.

18. The near-eye display device according to claim 17, wherein a refractive power of the fourth light modulation region is same as a refractive power of the first light modulation region, and a refractive power of the fifth modulation region is same as a refractive power of the second modulation region.

19. The near-eye display device according to claim 17, wherein an orthographic projection of the fifth light modulation region on the waveguide covers an entirety of an orthographic projection of the coupling-out grating on the waveguide.

20. The near-eye display device according to claim 11, wherein the optical waveguide structure further comprises a coupling-in grating on the first surface and spaced apart from the coupling-out grating, and the coupling-in grating is configured to couple the image light into the waveguide.
